(19) United States
(12) Patent Application Publication
(10) Pub. No.: US 2018/0050669 A1
(43) Pub. Date: Feb. 22, 2018

(54) A BRAKE CALIPER ASSEMBLY AND AN ASSOCIATED SUPPORT STRUCTURE FOR DISK BRAKES

(71) Applicant: ALTER EGO S.A.S., Roma (IT)

(72) Inventor: Alexander HOHENEGGER, Roma (IT)

(21) Appl. No.: 15/552,107

(22) PCT Filed: Feb. 18, 2016
(86) PCT No.: PCT/IB2016/050881

§ 371 Date: Aug. 18, 2017

(30) Foreign Application Priority Data
Feb. 18, 2015 (IT) PD2015A000044

(51) Int. Cl. B60T 1/06; B62K 19/38; B62L 1/00

(52) U.S. Cl. CPC B60T 1/065; B62L 1/005; B62K 19/38

(57) ABSTRACT

A brake caliper assembly and an associated support structure comprises an external casing, a pair of brake pads connected and capable of being actuated by actuating means in order to impart braking force on the disc and comprising respective support elements and a layer of friction material. The support structure comprises a connecting arm that connects the caliper to the fork and a strut element capable of being subjected to compression or traction that extends between the support elements and a fixing portion provided on the fork and is connected to the support elements by means of a connecting element separate and independent from the external casing.

The present invention relates to a brake caliper assembly and associated support structure, in particular intended to be fitted to bicycles and motor vehicles.

Calipers for disc brake systems intended for terrestrial vehicles are essentially divided into two different types.

In a first case, described for example in EP 014101, the brake uses a fixed caliper, in which the brake pads are held in position by one or more holes present in a metal support of said pads using related retaining pins or slot systems. In this solution, the force of the braking action occurs on one essentially linear side, in contact with the related abutment surface present on the body of the caliper. The caliper is rigidly attached to a portion of a suspension system or of a chassis.

The pistons that press on the brake pads are necessarily opposite to the faces of the disc, and make it possible to compensate for the wear of the friction lining by maintaining the fixed position of the caliper body by means of the approach of the pistons in a symmetrical and mirror-image fashion.

In a second case, on the other hand, the brake uses a floating caliper, in which the brake pads are again held in position by one or more holes and related retaining pins and/or by means of a slot system, and the force may occur on an essentially linear or circular side depending on the type of support of said caliper.

In this type of brake, the caliper body contains the piston (or pistons), which presses (or press) on the brake pad and is (or are) preferably positioned on the outer face of the disc. The caliper body is attached to the related support in a semi-rigid manner, since it has the ability to move in translatory motion on an axis transverse to the plane of the disc in order to compensate for the wear of the friction lining, moving away progressively towards the side of the pressing piston/s. The caliper support, on the other hand, is rigidly attached to a portion of a suspension system or of a chassis. Typically, the choice of one or the other solution is based on specific design requirements, depending on the characteristics that it is necessary to exploit.

The two solutions differ particularly in terms of dimensions, sensitivity to commands, weight and resistance to stresses, for example due to impacts.

Moreover, in both cases it would be desirable to have a greater capacity for heat dispersion.

In addition, a further relatively critical aspect in the known disc brake systems is linked to the fact that it is necessary to remove the calipers in order to dismantle the wheels, and this makes the operation more complex and costly in terms of time.

The technical problem underlying the present invention is therefore that of providing a disc brake system of a type capable of being used on all motorcycle brake discs and structurally and functionally designed to possess, at the same time, characteristics normally inherent only in fixed-caliper systems or only in floating-caliper systems, while simultaneously providing an improvement in terms of heat dispersion and simplicity of dismantling.

This problem is solved by means of the brake caliper assembly and associated support structure according to claim 1.

Preferred features of the invention are defined in the dependent claims.

The present invention makes it possible to provide a braking system in which there is a high braking force and, at the same time, a good resistance to impacts and stresses. The present invention is also particularly flexible both in terms of positioning and in terms of dimensions and therefore braking performance.

Moreover, these advantages have the consequence of providing excellent performance in terms of heat dispersion. In addition, the invention makes it possible to dismantle the wheel without necessarily having to remove the caliper.

Moreover, according to preferred features of the present invention, the invention makes it possible to limit the torsional stresses on the brake caliper during the phases of braking.

In addition, the support can be easily fitted in a relatively simple manner, adapting easily to traditional forks.

The characteristics and further advantages of the invention will be made clearer by the following detailed description of a preferred but non-exclusive embodiment, illustrated by way of non-limitative example with reference to the accompanying drawings, in which:

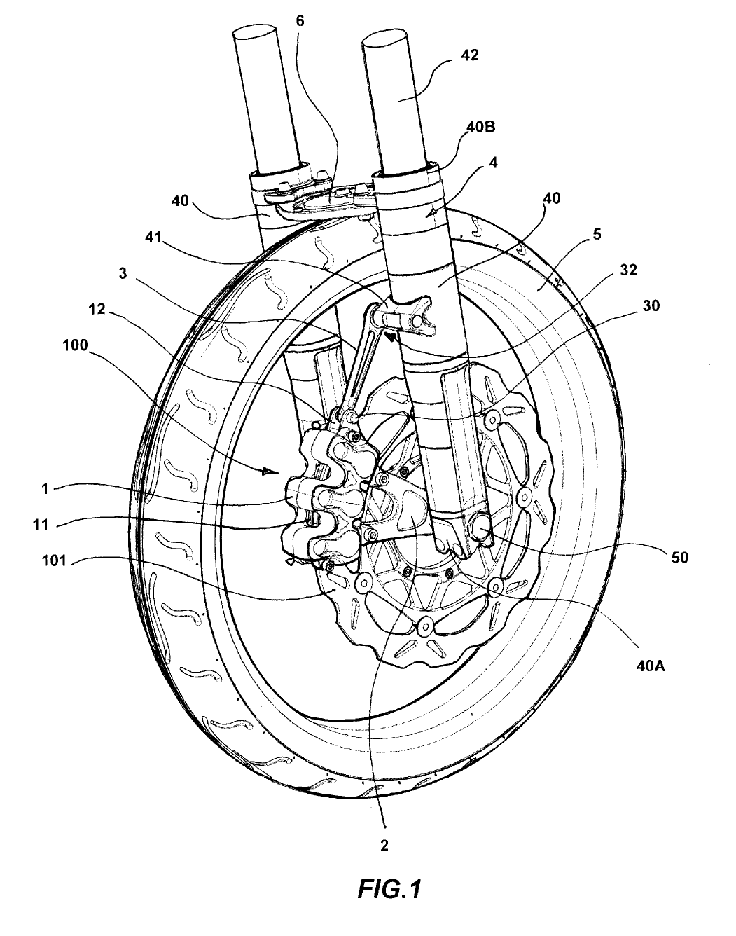

FIG. 1 is a perspective view of a front fork comprising a wheel rim and the brake caliper assembly and associated support structure according to the present invention;

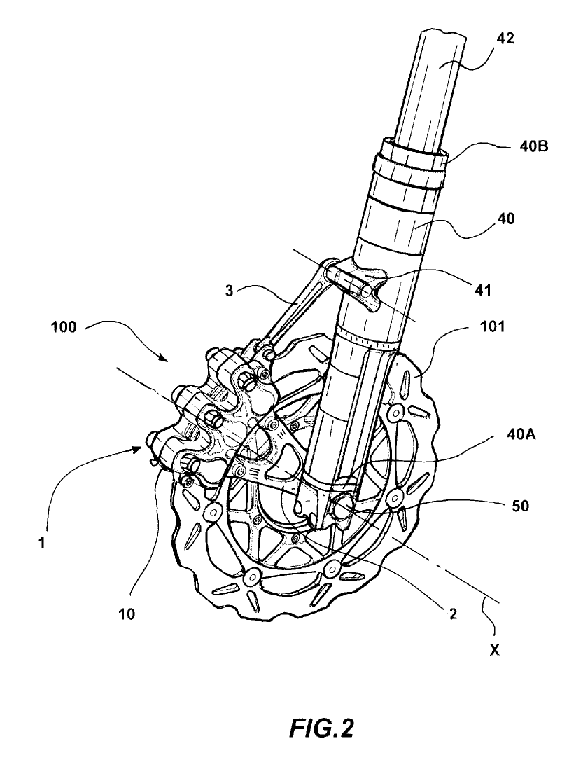

FIG. 2 is a perspective view of the fork of FIG. 1, from which the wheel and one tube/stanchion unit have been removed for greater clarity of illustration;

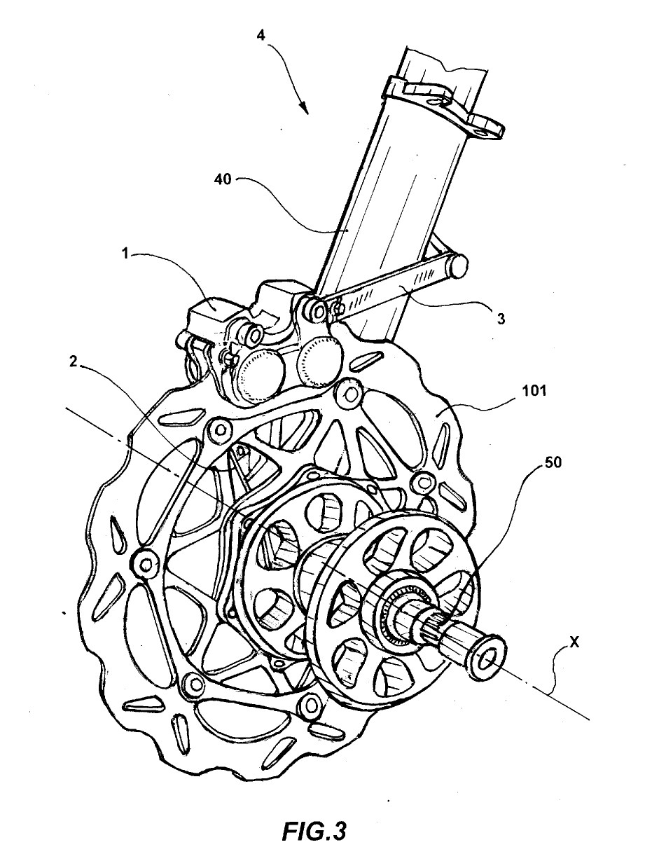

FIG. 3 is an illustration of the fork of FIG. 2 from a different perspective view;

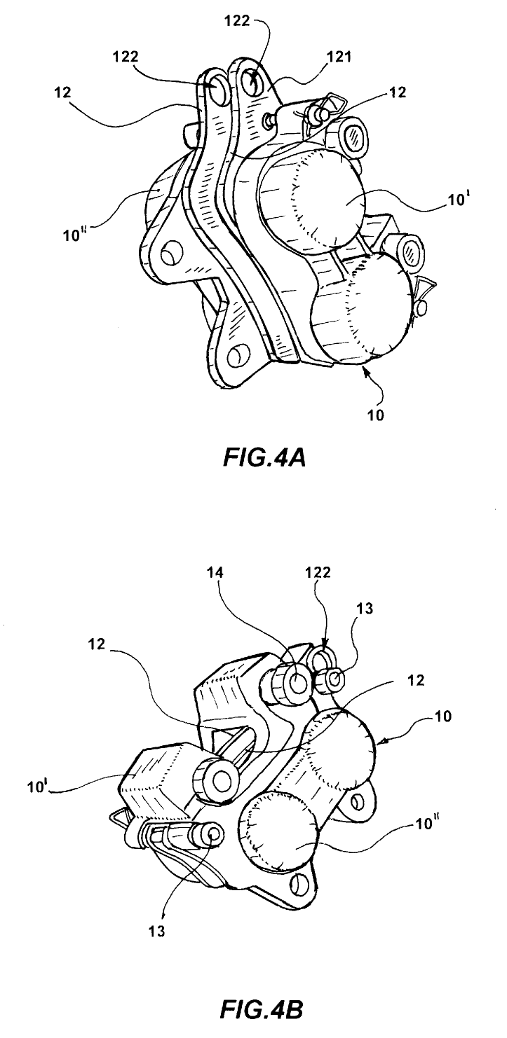

FIGS. 4A and 4B are two different perspective views of the brake caliper according to the present invention; and

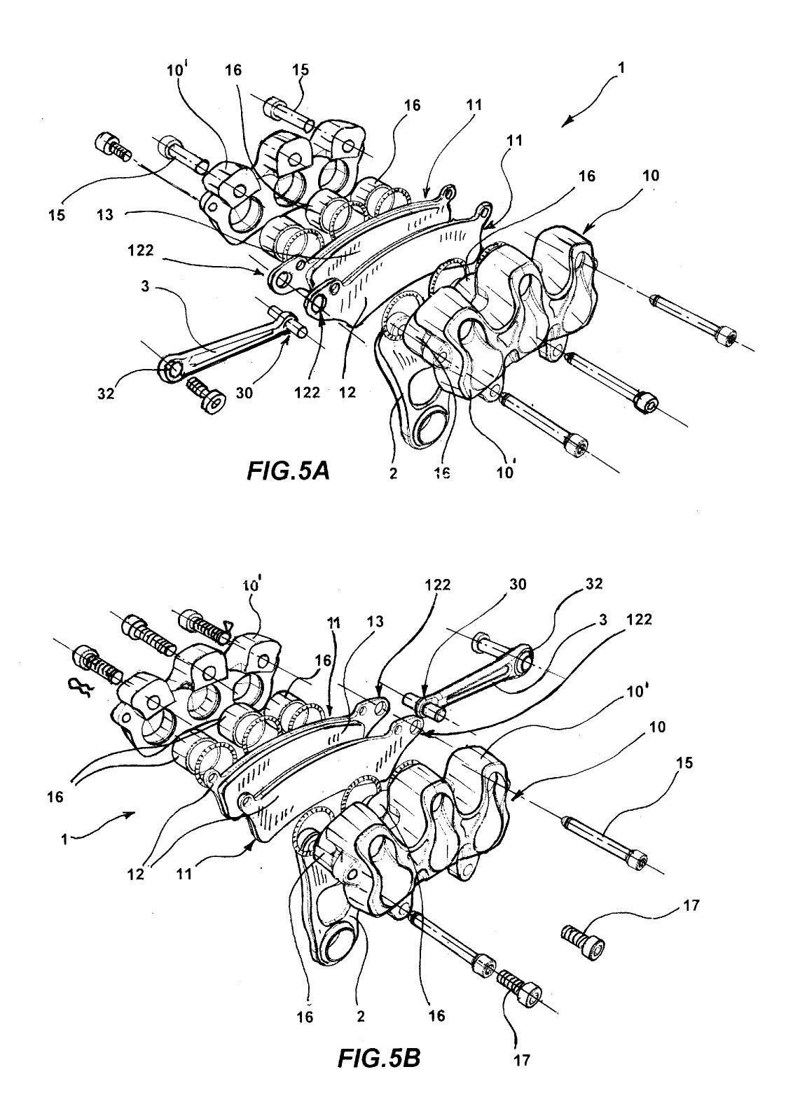

FIGS. 5A and 5B are two exploded views, from different points of view, of the brake caliper assembly and associated support structure according to the present invention.

With reference initially to FIG. 1, the front wheel 5 of a motorcycle is shown, fitted to a conventional fork 4, having a pair of tubes 40 connected to an axle pin 50 of the wheel 5, in the hub of the same, which defines an axis of rotation X, as illustrated more clearly in FIGS. 2 and 3.

It is noted that hereinafter, the word “fork” will be used to mean telescopic front suspension systems.

Regardless of the construction characteristics, “telescopic” in the context of the present invention will be considered to mean a suspension system in which there is an axial sliding between the fixed part, in this case the stanchion, and the moving part, in this case the tube, the former being attached to the sprung mass of the chassis and the latter to the unsprung mass of the wheel.

The tubes 40 therefore have a lower end 40A connected to the axle pin 50 of the wheel 5, and an upper end 40B through which are inserted respective stanchions 42 of the suspension system incorporated into the fork 4.

The upper ends of the two tubes 40 are optionally connected to each other by a lower bridge piece, not shown in FIG. 6, i.e. a connecting bridge forming part of the unsprung mass of the wheel 5.

Said upper ends also identify an upper portion of the tube 4.

A braking system of the wheel 5 is indicated as a whole by the reference number 100 and comprises a brake disc 101 with a related brake caliper 1, connected to the tube 40 by means of a support structure in a manner that will be illustrated in detail below. Therefore, with reference also to FIGS. 5A and 5B, the brake caliper 1 comprises an outer casing 10 inside which are housed the brake pads 11 connected to opposing inner surfaces of the casing 10, preferably defined by half-shells 10′ that form said casing.

According to a preferred embodiment, the brake pads 11 comprise a respective support element 12 and a layer of friction material 13, the latter being created in a manner that is known per se. The support elements 12 are supported in a sliding manner on the casing 10 by means of pins 15, thus allowing a motion of reciprocal approach/distancing of the brake pads 11. To this end, the support elements 12 further comprise through holes for the insertion of the pins 15.

Preferably, the brake pads 11 are driven towards each other by means of pistons 16, of which in this case there are three for each pad 11. However, it is evident that a different number of pistons may be provided, as for example in the embodiment of FIGS. 4A and 4B, where two pistons are used for each pad. The actuation of the pistons is carried out in a manner that is known per se and will therefore not be illustrated in any greater detail. It will also be appreciated that, as will become clearer below, the present invention makes it possible, with the same external dimensions as many conventional solutions, to use a greater number of pistons of equal diameter, thus increasing the contact area of the pad.

In any case, more generally, the brake caliper of the present invention comprises means for actuating the brake pads 11 that make it possible to move them towards each other by applying a braking force on the disc 101 and to release the disc at the end of the braking 13 that actuate the support elements 12 towards or away from the outer casing 10.

In this way, therefore, the pads 11 can be moved towards each other, imparting a braking force on the disc 101.

With reference now also to FIGS. 1 to 3, the support structure of the caliper comprises a connecting arm 2 and a strut element 3 intended to support the caliper 1 with respect to the fork 4.

According to a preferred embodiment, the connecting arm 2 connects the caliper 1 to the fork 4 at the level of the axis of rotation X of the wheel 5.

Preferably, the connecting arm 2 is slidably connected or connectable to the axle pin 50 of the wheel 5 along a direction parallel to the axis X. Alternatively, the connecting arm 2 may be directly connected to the tube 40 of the fork 4.

Preferably, the connecting arm is essentially fork-shaped, with the end opposite to the hub of the wheel 5 having a V or a U shape.

In the present embodiment, the connecting arm 2 and the casing 10 of the caliper 1 are fixed together by means of screws 17, in such a way that the caliper 1 and the connecting arm 2 are solidly united.

The strut element 3 extends between the support elements 12 and a fixing portion 41 arranged on the fork 4 and is capable of being subjected to compression or traction depending on the positioning of the brake caliper with respect to the axis of the fork. In the present embodiment, the strut element 3 is arranged in such a way as to be subjected to compression, the caliper 1 being arranged behind the tube 40 with respect to the direction of travel of the vehicle.

However, it should be understood that if the caliper were arranged in front rather than behind, as is the case in the embodiment of FIG. 3, the strut element 3, retaining the connections described above, would continue to perform its function but subjected to traction rather than compression.

Preferably, again with reference to FIGS. 1, 5A and 5B, an upper end of the strut element 3 is articulated at the level of the fixing portion 41, located above the caliper 1, in an intermediate position along the tube 40. In the present embodiment, the fixing portion 41 is created directly on the structure of the tube 40. However, the application of a separate component creating the fixing portion may be provided for. According to a preferred embodiment, the strut element 3 comprises, at the level of its connecting end with the fixing portion 41, a ball joint 32 with constraint to various degrees of freedom. Advantageously, this solution allows quick dismantling of the wheel by simply removing its axle pin, making it possible to easily remove the brake caliper during the phases of dismantling.

Again with reference to FIGS. 1, 5A and 5B, the strut element 3 is also connected to the support elements 12 via a connecting element 30, which preferably comprises a pin with respective ends 31 slidably connected to through holes 122 created on each support element 12.

More generally, the connecting element 30 is separate and independent from the outer casing 10, relative to which the support elements 12 can slide in a direction of reciprocal approach/distancing.

In other words, the connecting element 30, and therefore the strut element 3, is connected to the outer casing 10 solely by means of the support elements 12, there being no connection directly or by means of other components between the strut element 3 and the casing 10.

Preferably, the through holes 122 are created on the respective extensions 121 of the support elements 12 projecting from the outer casing 10, or are located elsewhere while remaining reachable by the connection element 30.

According to a preferred embodiment, the extensions 121 point upwards towards the fixing portion 41, and in any event are preferably as close as possible to the disc 101. This latter characteristic makes it possible, in particular, to minimise the stresses on the pins 15. However, it should be noted that the pins 15 provide the connection between the two units formed by connecting arm 2-enclosure 10 and strut element 3-support elements 12, and suitable play must be provided between the pins 15 and the related holes.

With reference once again to FIG. 2, preferably the strut element 3 lies on a plane included between the support elements 12 and, again preferably, the brake pads 11 as a whole are arranged in positions that are symmetrical to each other with respect to the plane on which the strut element 3 lies.

According to a preferred embodiment, this symmetrical arrangement also allows the outer casing to be created in two symmetrical half-shells 10′, thus allowing greater simplicity from the construction point of view.

It should also be noted that, according to a preferred embodiment, the plane on which the strut element 3 lies coincides with a plane defined by the disc 5 of the brake 100. It should be noted that although in the present embodiments the upper end of the strut 3 element is connected to an intermediate portion of the tube 40, different construction solutions may also be provided for.

In particular, the upper end of the strut element 3 may also be located at the level of different portions of the suspension system or of the chassis of the vehicle, as may occur for example in the case of a rear brake or a leading-link fork of the Earles type. For example, said end may be articulated to a connecting bridge between the tubes 40, at a point adjacent to the corresponding tube. This mounting solution requires only minimal modification to a suspension system of the conventional type.

As is evident from the description given earlier, the support element 2 supports the caliper 1 which, during braking, discharges its force, driven by the disc 101, on the engagement portion of the tube 40 through the strut element 3 hinged between the support elements 12 and the tube 40.

This design eliminates the torsion on the caliper caused by the misalignment of the known systems, which necessarily provide a constraint on one side of the brake disc.

In particular, according to preferred embodiments, the strut element 3 makes it possible to discharge the force generated on the neutral axis of the caliper 1, i.e. on the centre-line plane of the disc 101, divided between the strut element 3 and the connecting arm 2.

It should also be noted that the connecting arm is arranged in a radial position with respect to the axle pin 50, the disc 101 and the caliper 1.

In the arrangement described above, preferably the axis of the strut element 3 lies essentially on the radial plane of the brake disc, in order to ensure the alignment, during braking, of the contact surfaces between the plane of the brake pads and the planes of the disc.

In addition to the elimination of twisting forces, it is noted that all the attachments between the caliper casing 10 and the support structure 2 may be fixed, like the connection between the support structure and the relevant tube.

The support according to the present invention has been described here with reference to a single brake disc and the respective tube, i.e. the tube arranged on the same side of the disc.

However, it should be understood that said support could also be provided on both discs of a twin-disc system where the discs are arranged in an essentially mirror-image fashion, or on only one disc of a twin-disc system.

The invention thus solves the proposed problem, while simultaneously providing numerous advantages. In particular, it makes it possible to separate the two functions of housing the suspension unit and supporting the brake performed by the tube 40, offering modular possibilities that are useful for adapting the entire braking system depending on the type, for example with radial or axial calipers, choice of materials and number and size of pistons.

The support structure of the caliper, and in particular the connecting arm 2, is far less stressed, working only in compression, compared with a caliper of the radial type, so that the screws attaching the caliper can be made smaller.

The symmetrical positioning with respect to the radial axis makes it possible, if the semi-shells are produced by casting or forging, to create a single mould for both sides and therefore for both calipers. Similarly, all machining operations can be identical. Moreover, it is no longer necessary to provide a direct brake support in the tube, giving a higher degree of useful modularity for adapting the entire braking system according to the offset and diameter dimensions of the disc required for the various applications.

When the strut element 3 is connected directly to the bridge between the tubes, said tubes no longer need to withstand the torsional stresses exerted by the caliper and can therefore be made from a non-isotropic material such as carbon fibre, with a relative reduction in overall weight.

In addition, the use of an upper attachment of the strut element with an articulated constraint with multiple degrees of freedom allows the wheel to be rapidly dismantled by removing only its axle pin. This is an extremely useful characteristic in competitions, especially those of the Endurance type.

The special structure of the caliper 1, in which the support elements 12 extend outside the casing, also allows a greater exposure to the air, particularly with respect to the fixed design, thus ensuring greater dispersion of the heat before it can overheat the hydraulic fluid, which is extremely sensitive to high temperatures. By providing perforations as necessary, the surface areas of the metal supports 12 may exceed the profile of the casing 10, not being constrained within said profile.

Advantageously, when used in off-road vehicles, in the event of any deformation of the disc caused by impacts, there will be a natural self-alignment of the caliper due to the concentration of forces on the neutral axis.

Finally, as already mentioned, the separation of the forces present that normally act on a fixed caliper, those caused by the pressure of the pistons and those associated with the containment of the pads, makes it possible to eliminate the internal contact abutment between the pads and the casing of the caliper. This allows the elimination of the longitudinal end portions that are typically present in a fixed caliper, offering a larger braking surface area for the same dimensions. By way of example, the dimensions of a fixed caliper with four pistons according to the present invention are equivalent to a caliper with six pistons of equal diameter in a caliper according to the prior art, with a consequent increase in the useful surface area of the pads.

1. A brake caliper assembly and an associated support structure for disc brakes, of the type used on bicycles and motor vehicles, wherein a caliper comprises an external casing, a pair of brake pads connected to opposing surfaces of said external casing and capable of being actuated by an actuator to impart braking force on the disc, said brake pads comprising respective support elements and a layer of friction material, both supported in a sliding manner on said external casing, and wherein said support structure comprises a connecting arm that connects the caliper to the fork and a strut element capable of being subjected to compression or traction, wherein said strut element extends between said support elements and a fixing portion provided on the fork and is connected to said support elements by a connecting element separate and independent from said external casing, relative to which said support elements can slide in a direction of reciprocal approach/distancing, said support elements comprising a respective extension in correspondence of which said strut element is connected by said connecting element.

2. The brake caliper assembly and associated support structure according to claim 1, wherein said extension protrudes from said external casing.

3. The brake caliper assembly and associated support structure according to claim 2, wherein said extension comprises a respective through hole and said connecting element comprises a pin with respective extremities connected in sliding fashion to said through holes.

4. The brake caliper assembly and associated support structure according to claim 3, wherein said respective extremities are connected in pivoting fashion to said through holes.

5. The brake caliper assembly and associated support structure according to claim 1, wherein said strut element lies on a plane included between said support elements.

6. The brake caliper assembly and associated support structure according to claim 5, wherein said support elements and the associated brake pads are arranged symmetrically with respect to said plane on which the strut element lies.

7. The brake caliper assembly and associated support structure according to claim 5, wherein said plane coincides with a plane defined by the disc of the brake.

8. The brake caliper assembly and associated support structure according to claim 1, wherein said connecting arm connects the caliper to the fork at the axis of rotation of the wheel.

9. The brake caliper assembly and associated support structure according to claim 8, wherein said connecting arm is slidably connected or connectable to a pin of the wheel along a direction parallel to the wheel axis.
